(19) United States
(12) Patent Application Publication
(10) Pub. No.: US 2016/0321899 A1
(43) Pub. Date: Nov. 3, 2016

(54) SAFETY DETECTOR SYSTEM

(71) Applicant: Garfield Ron Mingo, East Orange, NJ (US)

(72) Inventor: Garfield Ron Mingo, East Orange, NJ (US)

(21) Appl. No.: 15/138,406

(22) Filed: Apr. 26, 2016

Related U.S. Application Data
(60) Provisional application No. 62/153,929, filed on Apr. 28, 2015.

(51) Int. Cl. G08B 17/10; H04W 4/12; G08B 25/10; G08B 21/14; G08B 25/01

(52) U.S. Cl. CPC G08B 17/10; G08B 21/14; G08B 25/016; G08B 25/10; H04W 4/12

(57) ABSTRACT

A safety apparatus is provided. The safety apparatus includes an alarm device having at least one of a smoke detector and a carbon monoxide detector. The present invention may further include an actuator. The actuator is connected to a window and is operable to open and close the window. The actuator may be electrically connected to the alarm device. Therefore, when the alarm device detects either smoke or carbon monoxide, the alarm device sends a signal to the actuator, which in turn opens the window.

### CROSS-REFERENCE TO RELATED APPLICATION

This application claims the benefit of priority of U.S. provisional application No. 62/153,929, filed Apr. 28, 2015, the contents of which are herein incorporated by reference.

### BACKGROUND OF THE INVENTION

The present invention relates to a safety detector system and, more particularly, to a safety detector system that detects at least one of smoke and carbon monoxide and opens a window in response.

A carbon monoxide detector or CO detector is a device that detects the presence of the carbon monoxide (CO) gas in order to prevent carbon monoxide poisoning. A smoke detector is a device that senses smoke, typically as an indicator of fire. Commercial security devices issue a signal to a control panel as part of a fire alarm and carbon monoxide alarm system, while household detectors, known as smoke alarms, generally issue a local audible or visual alarm from the detector itself. Currently, detectors notify a building dweller that there may be a fire or a carbon monoxide leak. However, current detectors fail to reduce the potential danger of a fire and a carbon monoxide leak.

As can be seen, there is a need for a safety detector system that reduces potential danger caused by fire and carbon monoxide.

### SUMMARY OF THE INVENTION

In one aspect of the present invention, a safety apparatus comprises: an alarm device comprising at least one of a smoke detector and a carbon monoxide detector; an actuator connected to the alarm device and operable to open a window when activated, wherein the alarm device detects at least one of smoke and carbon monoxide and activates the actuator.

In another aspect of the present invention, a safety apparatus comprises: a window comprising at least a portion operable to open and close; an alarm device secured within a close proximity of the window, wherein the alarm device comprises at least one of a smoke detector and a carbon monoxide detector; and an actuator connected to the alarm device and operable to open the portion of the window when the alarm device detects at least one of smoke and carbon dioxide.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a schematic view of an embodiment of the present invention; and

FIG. 3 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a smoke and carbon monoxide detector window. The windows of the present invention automatically open when either smoke or carbon monoxide is detected in a building. Further, the alarm may send a message to a mobile device indicating what the alarm has detected and where. The present invention opens a window so that fumes from a fire or carbon monoxide can escape the building. Therefore, the present invention increases the likelihood of survival for building dwellers.

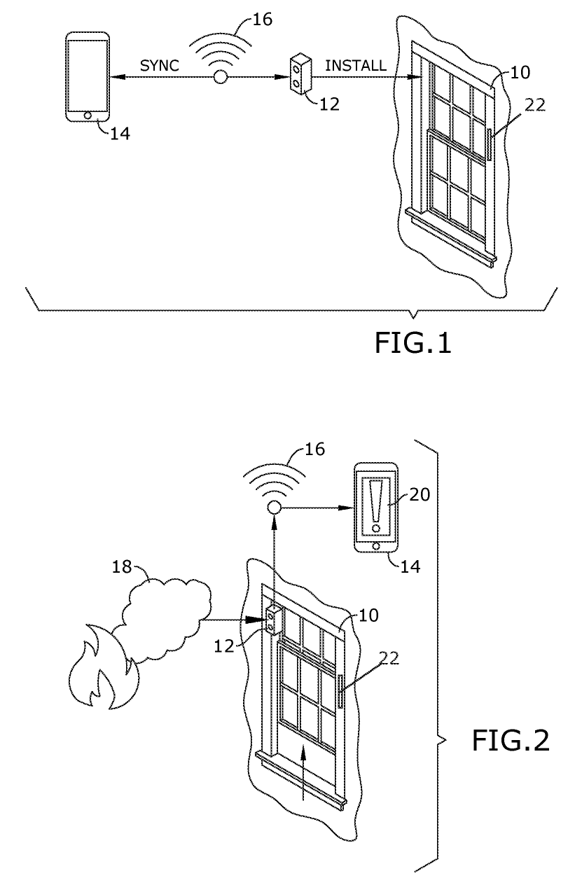

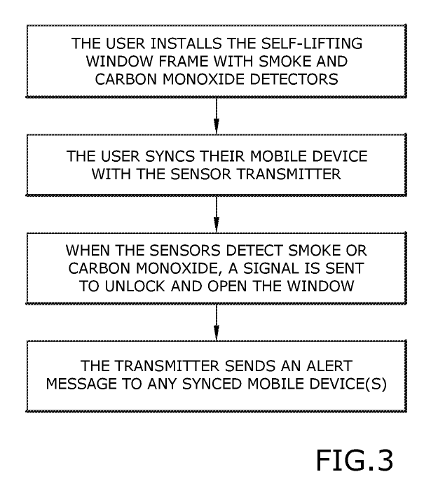

Referring to FIGS. 1 through 3, the present invention includes a safety apparatus. The safety apparatus includes an alarm device 12 having at least one of a smoke detector and a carbon monoxide detector. The present invention may further include an actuator 22. The actuator 22 is connected to a window 10 and is operable to open and close the window 10. The actuator 22 may be electrically connected to the alarm device 12. Therefore, when the alarm device 12 detects either smoke or carbon monoxide 18, the alarm device 12 sends a signal to the actuator 22, which in turn opens the window 10.

The window 10 of the present invention may be any type of window 10 that has an openable portion. For example, the window 10 may be a sliding window, a pivoting window, a hinged window, and the like. The actuator 22 of the present invention may include any actuator 22 operable to open the window 10. For example, if the window 10 is a sliding window, the actuator 22 may be a linear actuator 22. If the window 10 is a pivoting window, the actuator may be a rotary actuator 22.

In certain embodiments, the alarm device 12 of the present invention includes a wireless transmitter. The wireless transmitter is operable to transmit a message 20 to a remote device 14 that at least one of smoke and carbon monoxide 18 has been detected by the alarm device 12. The wireless transmitter may be part of a wireless local area network 16. Therefore, the message 29 may be sent to the remote device via WiFi. The remote device 14 may be a smart phone. In such embodiments, the present invention may include a software that is programmable to designate multiple smart phones to receive the message 20 from the alarm device 12. Therefore, the owner of the building, family members and friends may receive the message 20 from the alarm device 12. The message 20 may be in the form of at least one of an audio message via a phone call and a text message.

When the window 10 is opened triggered by the alarm device 12, air will cycle so that at least some of the smoke and carbon monoxide are removed from the building. Since the alarm device 12 has an automatic transmitter, the present invention sends a message 20 in the form of a text or a phone call, to alert friends or family of a possible house fire or carbon monoxide leak. The alarm device 12 may include both a carbon monoxide and smoke sensor. The combination of the two sensors alerts the users if either carbon monoxide or smoke 18 is found in the air, and further the system opens the window 10 to exhaust dangerous fumes.

It should be understood, of course, that the foregoing relates to exemplary embodiments of the invention and that modifications may be made without departing from the spirit and scope of the invention as set forth in the following claims.

What is claimed is:

1. A safety apparatus comprising:
an alarm device comprising at least one of a smoke detector and a carbon monoxide detector; and
an actuator operable to open a window when activated, wherein
the alarm device detects at least one of smoke and carbon monoxide and activates the actuator.

2. The safety apparatus of claim 1, wherein the alarm device further comprises a wireless transmitter operable to transmit a message to a remote device that at least one of smoke and carbon monoxide has been detected by the alarm device.

3. The safety apparatus of claim 2, wherein the remote device is a smart phone.

4. The safety apparatus of claim 3, wherein the message is in the form of at least one of an audio message via a phone call and a text message.

5. The safety apparatus of claim 2, wherein the wireless transmitter is part of a wireless local area network.

6. A safety apparatus comprising:
a window comprising at least a portion operable to open and close;
an alarm device secured within a close proximity of the window, wherein the alarm device comprises at least one of a smoke detector and a carbon monoxide detector; and
an actuator electrically connected to the alarm device and operable to open the portion of the window when the alarm device detects at least one of smoke and carbon dioxide.

7. The safety apparatus of claim 6, wherein the alarm device further comprises a wireless transmitter operable to transmit a message to a remote device that at least one of smoke and carbon monoxide has been detected by the alarm device.

8. The safety apparatus of claim 7, wherein the remote device is a smart phone.

9. The safety apparatus of claim 8, wherein the message is in the form of at least one of an audio message via a phone call and a text message.

10. The safety apparatus of claim 6, wherein the alarm device is secured to the window.
